(19) United States
(12) Patent Application Publication
(10) Pub. No.: US 2007/0285426 A1
(43) Pub. Date: Dec. 13, 2007

(54) Graph with zoom operated clustering functions

(76) Inventor: Nicholas A. Matina, Oceanside, CA (US)

Correspondence Address: Rutan & Tucker, LLP.;Hani Z. Sayed, 611 ANTON BLVD, SUITE 1400, COSTA MESA, CA, 92626, US

(21) Appl. No.: 11/450,245

(22) Filed: Jun. 8, 2006

(51) Int. Cl. G06T 11/20

(52) U.S. Cl. 345/440

(57) ABSTRACT

Software and methods of graphic representation of data are contemplated in which the data points are displayed in a clustered and/or de-clustered format as a function of a user zooming in and out of the display. Most preferably, the zoom is a continuous zoom, and the program further allows for panning within the display.

### FIELD OF THE INVENTION

The field of the invention is data manipulation and display of manipulated data.

### BACKGROUND OF THE INVENTION

Graphic representation of data points from numerous sources is a common tool to obtain information on particular characters, trends, and other parameters. Most typically, and especially where there is a wealth of data points to be displayed, at least some information content is lost at any given magnification. For example, where data points are taken in millisecond intervals for a period of 24 hours, display of the entire 24 hour data will result in loss of resolution and obscure brief spikes or other short-term irregularities. On the other hand, where only a few seconds or even shorter intervals are displayed, spikes, short-term irregularities, or brief trends tend to be overemphasized where no larger context is visible.

To circumvent such problems associated with data management of large quantities of data points, numerous approaches have been implemented over the last decades. In one approach, a user can select the magnification at which the data points are being viewed. Most typically, the magnification factor is predetermined and the display is refreshed to present the graph in the new selected magnification. In another approach, a user can define an area of the graph that is to be magnified and the selected area is then presented, for example, in a new window at a desired magnification. While such approaches typically provide at least some more detailed insight into the data points in a certain interval, several difficulties nevertheless remain. Among other things, where the entire display is magnified, a new magnification factor must be selected where the magnification factor is not suitable for the user. Therefore, multiple attempts are often needed to arrive at the desired detail level. Alternatively, where a second window is opened that provides a magnified view, changes in magnification are typically not available in that view and a new window must be opened. Furthermore, the second window is typically constrained to an area that was selected by the user, and changes in the covered area typically require the magnified view to be closed and reopened.

In still further known manners of magnification, a virtual magnifying lens is provided on the screen that can be moved across the graph. The corresponding data that fall within the virtual magnifying lens are then interactively displayed such that magnification can be applied to the graph in different regions by moving the lens over the area that is to be magnified. While such methods advantageously allow for some flexibility in magnifying different areas in a continuous manner (i.e., without opening and closing the magnified view), the magnification factor is typically fixed.

Regardless of the manner of magnification, currently known methods to increase and/or decrease magnification will typically either result in loss of information by loss of resolution (i.e., loss of detail information) when the magnification is decreased, or result in loss of information by loss of data quantity (i.e., loss of context information) when the magnification is increased. Such loss of information is typically not remedied with additional displays or virtual magnifying lenses as such methods rely on display of the same information using the same original data.

Thus, while numerous manners of displaying a plurality of data points in a graph or other format are known in the art, numerous difficulties remain. Consequently, there is still a need to provide improved programs and methods to display a plurality of data points.

### SUMMARY OF THE INVENTION

The present invention is directed to programs and methods of presentation of a plurality of data points in which at least some of the data points are clustered into higher level clusters and/or de-clustered from higher level clusters to lower level clusters or even original data, wherein deconvolution and agglomeration are a function of a user that zooms in and/or out of a display. Using such data presentation, excessive detail information is avoided by agglomeration of data into a higher level cluster while loss of detail information is avoided by deconvoluting higher level clusters into more detailed data presentation. Preferably, the clustered and/or de-clustered data points are displayed concurrently with the display in which the zooming operation was performed, and contemplated programs and methods allow for continuous zooming in and out as well as for panning within a display.

Therefore, in one especially preferred aspect of the inventive subject matter, a software is programmed to allow a user on a computer to change presentation of data points in a graph between a clustered form and a de-clustered form in response to a zoom function in the graph. Typically, the software is programmed to clustered data points in response to a zoom-out function and to de-cluster clustered data in response to a zoom-in function. Preferably, the software is also programmed to employ a mathematical function and/or manual user input to thereby produce the clustered or de-clustered form, and the software allows presentation of the data points in both the clustered form and the de-clustered form (most preferably in an overlapping manner). Among other suitable formats, particularly preferred graphs include line graphs, bar graphs, scatter plots, and/or a pie graphs, in which the data points represent a numeric value of a physical descriptor, a monetary descriptor, an anatomical descriptor, and/or a demographic descriptor.

In another preferred aspect of the inventive subject matter, the software is programmed to allow a user on a computer to (1) present a first display of a plurality of data points in an at least two-dimensional graph using a first data point per scale resolution, (2) allow a user to zoom within the first display within a range that is characterized by at least one of a predetermined minimum and maximum of data points per scale in at least one dimension of the first display, and (3) present a second display of the plurality of data points in an at least two-dimensional graph using a second data point per scale resolution once the user zooms outside the range.

In such programs, it is generally preferred to employ a mathematical function and/or a manual user input to establish the second data point per scale resolution, and/or to establish the predetermined minimum and maximum of data points per scale. It is still further preferred that the software is programmed to clustered the plurality of data points once the user zooms to a point exceeding the maximum data points per scale, and that the software is further programmed to de-cluster a clustered plurality of data points once the user zooms to a point dropping below the minimum data points per scale. Most preferably, the software provides a continuous zoom function, and optionally a continuous pan function in the first and/or second displays (which can be concurrently displayed in an optional overlapping manner).

In a still further preferred aspect of the inventive subject matter, the software is programmed to allow a user on a computer to acquire a plurality of data points P having a point format P(DₙQₘ)(Dₙ₊₁Qₘ₊₁)(Dₙ₊ . . . Qₘ₊ . . . ), wherein D is a descriptor and Q is a quantifier of the descriptor. The software will then apply a rule using at least one of a mathematical function and operator input to generate from the plurality of data points P a plurality of derivative data points P′ having a point format

$${P}^{′} ( \begin{matrix}{DQ}_{m} 1 \\ {D}_{n} {DQ}_{m} 2 \\ {DQ}_{m} 3 \\ {DQ}_{m} …\end{matrix} ) ( \begin{matrix}{DQ}_{m + 1} 1 \\ {D}_{n + 1} {DQ}_{m + 1} 2 \\ {DQ}_{m + 1} 3 \\ {DQ}_{m + 1} …\end{matrix} ) ( \begin{matrix}{DQ}_{m + …} 1 \\ {D}_{n + …} {DQ}_{m + …} 2 \\ {DQ}_{m + …} 3 \\ {DQ}_{m + …} …\end{matrix} )$$

wherein DQₘ1, DQₘ2 DQₘ3, and DQₘ . . . represent a fractional, an identical, and/or a collective expression of Qₙ. Most typically, the software is programmed such that at least some of the data points are presented in a display format in which a unit of at least one of DQₘ1, DQₘ2, DQₘ3, and DQₘ . . . is used as scale for display. The software typically further allows zooming of the display format by at least one of expanding and compressing the scale, and to concurrently present (at a predetermined expansion or compression of the scale) a second display of the data points in a second display format in which a second unit of at least another one of DQₘ1, DQₘ2, DQₘ3, and DQₘ . . . is used as scale for the second display. Preferably, D can be a physical descriptor, a monetary descriptor, an anatomical descriptor, and/or a demographic descriptor, while Q can be a numeric value, a candidate name, and/or a medical grading.

In such software, it is typically preferred that acquisition of the data points comprises transfer of the data points from a measuring device and/or another computer, and that the software allows for a continuous zoom function and/or an optional continuous pan function. Similar to the aspects presented above, the software is preferably programmed to present the display and the second display in an overlapping manner.

Various objects, features, aspects and advantages of the present invention will become more apparent from the following detailed description of preferred embodiments of the invention.

### BRIEF DESCRIPTION OF THE DRAWING

FIG. 1A is a screen image of an exemplary graph depicting clustered data points in a first zoom factor.

FIG. 1B is a screen image of an exemplary graph depicting the clustered data points of FIG. 1A in a second zoom factor.

FIG. 1C is a screen image of an exemplary graph concurrently depicting in overlapping manner the clustered data points of FIG. 1A and de-clustered data points in a third zoom factor.

FIG. 2 is a schematic of a system implementing a method according to the inventive subject matter.

### DETAILED DESCRIPTION

The inventor has discovered that a plurality of data points can be presented in a display in which the data points can be viewed at any given and variable zoom without losing relevant information associated with the data points. Most advantageously, as a user zooms in a graph or other display, a second display is generated and presented in which detail information of the zoomed-in area is displayed as a plurality of data points in a de-clustered manner. Similarly, as a user zooms out of a particular area, individual data points are clustered into appropriate higher level clusters to thereby prevent information overload and generate a meaningful information output. In especially contemplated aspects, the presentation of the data points allows for a continuous zoom-in and zoom-out function as well as for a continuous panning function.

As used herein, the term “continuous” when used in conjunction with the terms “zoom”, “zooming”, “pan”, or “panning” refers to the manner of presenting a plurality of display frames of a graphical representation of a plurality of data points, wherein the frames have a non-identical zoom factor or pan position, and wherein multiple frames (typically at least three, more typically at least 5, and most typically at least 10 frames) are presented in sequence upon a single user prompt (e.g., movement of a sliding bar, continuous pressing of a mouse button, or continuous pressing of a zoom and/or pan button). Most preferably, the sequence of frames is uninterrupted and gives an observer the impression of a smooth movement within the graphical representation. Remarkably, such manner of data presentation (and especially where the presentation is a line graph, bar graph, scatter plot, and/or pie graph) has not been appreciated in the art. Heretofore known manners of data presentation typically require multiple user prompts for multiple zoom- and/or pan factors. Viewed from another perspective, in all or almost all of the known data presentations, zooming in and/or out requires multiple user intervention/refresh cycles, which typically fail to provide a smooth, movie-like transition from one zoom- and/or pan factor to another.

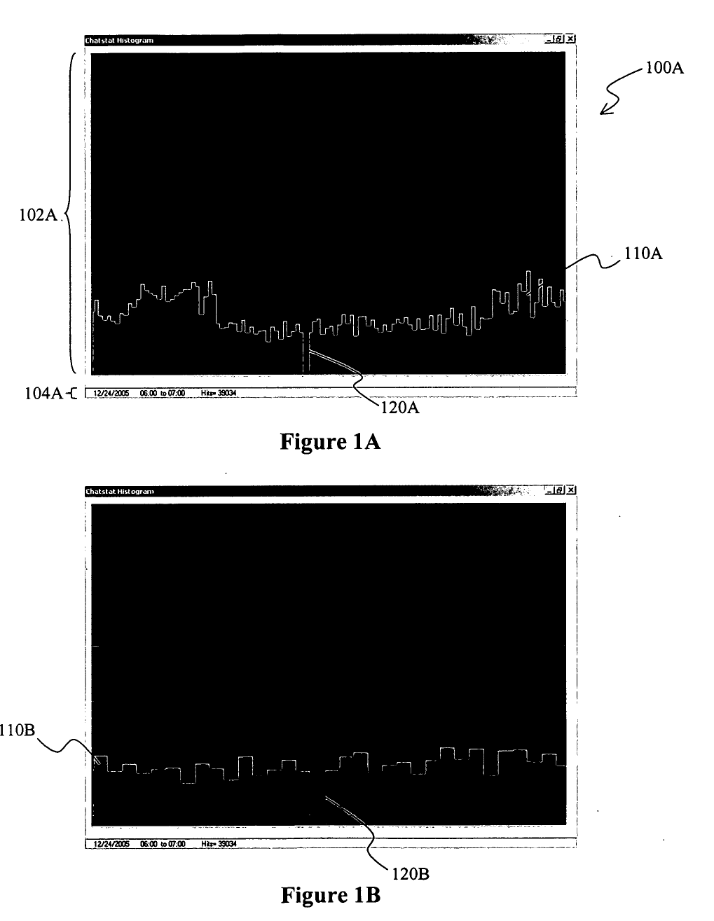

In one exemplary aspect of the inventive subject matter, software is programmed to allow a user on a computer to change presentation of data points in a graph between a clustered form and a de-clustered form in response to a zoom function in the graph. Most typically, but not necessarily, the software is programmed to clustered data points in response to a zoom-out function and/or to de-cluster clustered data in response to a zoom-in function. FIGS. 1A-1C depict an exemplary implementation of such programming in which the number of hits to a website (ordinate) is plotted as a function of time (abscissa). In FIG. 1A, a window 100A is depicted having a plot area 102A and detail area 104A. Vertical bars 110A represent a daily total of hits to a website at a particular day, and a double lined detail pointer 120A, movable within the graph using mouse movement, embraces the borders of a selected vertical bar. The detail area 104A provides detail information about the clustered data (infra) within the selected vertical bar (here: 39034 hits on Dec. 24, 2005). The mouse pointer (not shown in this view) can be moved within the double lined detail pointer 120A to a specific portion of the day (here: time between 6:00 and 7:00 AM on Dec. 24, 2005). In the view of FIG. 1A, the bar of interest (between double lined detail pointer 120A) is surrounded by data representing about 2 months prior and after the selected date, providing a relatively wide perspective.

Upon left-click with the mouse, the program continuously zooms in to the selected area to thereby provide a magnified and more detailed view of the time frame around the selected date (Dec. 24, 2005) as shown in FIG. 1B. In the magnified view, the bar of interest is now surrounded by data representing about 2 weeks prior and after the selected date. Most preferably, as the user zooms in to the graph, the ordinate is continuously rescaled to the increased resolution. It should be noted that in this view, the vertical bars 110B and the double lined detail pointer 120B have an increased width. With respect to the detail bar, the same considerations as above apply.

As the user continues to zoom-in the graph as illustrated by exemplary FIG. 1C, a meaningful representation of the temporal context of the selected bar is lost as the entire graph depicts only daily totals of hits to the website of about 1 week. However, it should be noted that at this resolution, a meaningful representation of de-clustered data that lead to the clustered data represented by the vertical bar of FIGS. 1A and 1B is realized by overlapping the view of the vertical bar with a display of the de-clustered data as represented by vertical bars 112C. Bars 112C now represent the hourly hits to the website within the selected day, and the detail area 104C now shows the hourly hits that are identified by the double lined detail pointer 120C. In this example, the width of the double lined detail pointer 120C is adjusted to the lowest available width (i.e. hourly resolution) of the vertical bars. It should be recognized that further zoom-in beyond the magnification of FIG. 1C may done. For example, further zoom-in may provide a view of the entire day with a first generation deconvolution to depict hourly hits, and an additional second generation deconvolution depicting 10-minute total hits within each hourly vertical column 112C. Conversely, as a user zooms out of the graph, display of the 10-minute total hits can be clustered to hourly totals, which can be further clustered to a display of daily totals, which still further be clustered to weekly totals, which in turn can be clustered to monthly totals, and so forth.

Therefore, it should be especially appreciated that the data point presentation is changed in response to zooming in and out of a graph or other data presentation in a manner that allows to manage total information content such that the total information content in the graph will not fall below a predetermined level and/or not rise above a total information content. Thus, at a certain zoom factor, the data presented in the graph will either be clustered to avoid display of an undesirably high number of data points, or de-clustered to avoid display of an undesirably low number of data points. Most typically, zooming in and/or out will be continuous, and the clustered and/or de-clustered display data will be presented in a second display (typically overlaid with the preceding display) as a predetermined zoom-in or zoom-out threshold is passed in the continuous zoom operation.

To that end, the software is preferably programmed to employ a mathematical function and/or manual user input to thereby produce the clustered or de-clustered form data points. For example, where the data can be clustered using an iterative or otherwise predictable function, data agglomeration and/or deconvolution can be performed using simple algorithms reflective of that function. Suitable functions typically include quantitative fractional/multiple measures (e.g., millimeter, centimeter, meter, kilometer; or second, minute, hour, day, week, etc.) and qualitative measures (e.g., small, medium, large; or regular, moderate, severe, extreme, etc. ), and all reasonable combinations thereof. Furthermore, contemplated data agglomeration and/or deconvolution may also employ multiple agglomeration and/or deconvolution parameters. For example, weight of measured particles can be expressed in purely quantitative fashion in one set of parameters (e.g., by absolute weight: microgram, milligram, gram, etc.), while another set of parameters may purely descriptive (e.g., ultra-small, very small, small, medium, etc.). In yet another example, the parameters can be mixed (e.g., microgram, milligram, small, medium, large, etc.).

Therefore, and viewed from another perspective, agglomeration of data points can be characterized as sorting and/or combining a plurality of data points into a higher level order while deconvoluting data points can be characterized as parsing clustered data points from a higher level order to a plurality of data points of lower level order. It should be especially pointed out that such hierarchal nesting will allow a user to view a large number of data points at any given zoom factor in a meaningful manner as agglomeration and deconvolution will maintain information in a categorized manner. Therefore, graphical representation of a high density of data points is typically accompanied by at least one summary (agglomeration) level, while graphical representation of a low density of data points is typically accompanied by at least one (de-clustered) detail level.

Agglomeration/deconvolution can be performed on demand (e.g., as the user approaches or reaches a certain zoom factor) using a mathematical function and/or previously collected user input, or may at least in part be performed using the original data. Therefore, the clustered and/or de-clustered data can be stored in memory (e.g., in a data base) or calculated from the original data. Regardless of the manner of generation of the clustered and/or de-clustered data, it is contemplated that the data points are presented in both the clustered form and the de-clustered form. It is generally preferred that the display of the data points is performed in an overlapping manner in which de-clustered data are presented together with the clustered data (as shown in FIG. 1C). However, in other aspects of the inventive subject matter, it should be recognized that a second (third, or higher) window can be generated where the clustered and/or de-clustered data are shown. Depending on the particular type of data and manner of presentation (e.g., 2-dimensional, 3-dimensional), it should be appreciated that suitable graphs include line graphs, bar graphs, scatter plots, pie graphs, etc. Still further, the data points may also be employed to generate a two-dimensional or three-dimensional map of an object. In such aspects, presentation of the clustered and/or de-clustered data is preferably faded in or out from the display. For example, where the data points are atomic space coordinates of a three-dimensional representation of a protein molecule, agglomeration can be qualitative and include in a first generation backbone structure, in a second generation secondary structure of the backbone, and in a third generation subunit structure, all of which are faded in and out as a user continuously zooms in and out.

Consequently, it should be appreciated that the data points may represent a large variety of data, and it is generally contemplated that the data points typically represent a numeric and/or qualitative value of a physical descriptor (e.g., size, weight, amount, etc.), a monetary descriptor (e.g., stock value, exchange rate, interest rate, account balance, etc.), an information technology descriptor (e.g., bit rate, memory use, IP addresses, website hits, etc.), an anatomical descriptor (e.g., organ description, disease state, grading, etc.), and/or a demographic descriptor (e.g., party affiliation, voter registration, previous voting history, congressional district, etc.). Furthermore, it should be noted that the graphs can be modified to include color coding that indicates the level of agglomeration and/or deconvolution, or that the graphs may include display options for numerical or other descriptive values.

In another preferred aspect of the inventive subject matter, and viewed form a different perspective, contemplated software can be programmed to present a first display of a plurality of data points in an at least two-dimensional graph (e.g., line graph, bar graph, scatter plot, pie graph, etc.) using a first data point per scale resolution, to allow a user to zoom within the first display within a range that is characterized by at least one of a predetermined minimum and maximum of data points per scale in at least one dimension of the first display, and to present a second display of the plurality of data points in an at least two-dimensional graph using a second data point per scale resolution once the user zooms outside the range. The term “data point per scale resolution” as used herein refers to the resolution of a graph characterized by the number of data points spread across the abscissa (and/or ordinate where appropriate).

With respect to the step of zooming by the user, it is contemplated that all known modes of zooming are deemed suitable for use herein. However, it is particularly preferred that the software is programmed to allow continuous zooming in and out of the graph. For example, zooming can be performed by recalculation and refreshing the graph area at a frame rate of between 1 and 30 frames per second, wherein the recalculation is preferably performed at a predetermined step rate (e.g., numerical scale increase is set to 2% per recalculation). Typically, a user will either slide a zoom bar or click a zoom button on the screen to a position or for a duration effective to achieve a desired zoom position. Alternatively, in less preferred aspects, the entire zoom range of the graph can be pre-calculated in predetermined steps and corresponding images are stored on the computer. Upon zoom activation, the images are then replayed in video mode. Similarly, panning within the display is preferably continuous, and it is especially preferred that the graph area is recalculated/refreshed at a frame rate of between 1 and 30 frames per second. As with the zooming, recalculation is preferably performed at a predetermined step rate (e.g., numerical scale shift is set to 5% per recalculation).

Regardless of the manner of zooming, it is typically preferred that the predetermined minimum and maximum of data points (clustered or de-clustered) per scale is set between 10 and 100, and most typically between 20 and 60 data points per abscissa. However, in further aspects of the inventive subject matter, numerous alternative minimum and maximum of data points are also deemed suitable and will typically lie between 2 and 10, or between 100 and 1000 (and even more). A person of ordinary skill in the art will readily be able to determined a suitable minimum and maximum of data points for a graph. In still further alternative aspects, the minimum and maximum of data points may also be calculated from the maximum quantity of data points and optionally other parameters (e.g., type of data, availability of log scaling, etc.) using one or more mathematical functions. Alternatively, or additionally, a user may set the predetermined minimum and maximum of data points per scale.

Depending on the zoom rate and the predetermined minimum and maximum of data points per scale, it should be recognized that the second data point per scale resolution may vary considerably. However, it is generally preferred that the second data point per scale resolution will correspond to a predetermined fraction or multiple of the first data point per scale resolution. For example, where the abscissa represents a distance measurement, first and second data point per scale resolutions may represent millimeter and meter. Therefore, it is contemplated that the software is programmed to use a mathematical function to establish the second data point per scale resolution. Alternatively, the software may also be programmed to allow for manual user input.

It is further preferred that the software is programmed to clustered the plurality of data points once the user zooms to a point exceeding the maximum data points per scale, and/or that the software is programmed to de-cluster a clustered plurality of data points once the user zooms to a point dropping below the minimum data points per scale. It should be appreciated that the agglomeration and/or deconvolution will generally follow the format as described above. Therefore, agglomeration and/or deconvolution will preferably be performed on demand using either predetermined algorithms (which may at least in part depend on the number or numerical quality of data points), or may include factors provided by the user. However, in at least some alternative aspects, agglomeration and/or deconvolution may also be performed prior to a zoom operation. Thus, the software may store and/or retrieve clustered and/or de-clustered data points in a memory, and use such stored data for display without further calculation. Depending on the type of graph and nature of data points (e.g., numeric value of at least one of a physical descriptor, a monetary descriptor, an anatomical descriptor, and a demographic descriptor), the second display can be provided in a separate window, in a floating graph above the first graph, or in a concurrent second display overlapping the first display.

In an exemplary aspect of contemplated software, the software can be programmed to allow a user on a computer to acquire (e.g., via manual entry, transfer from another computer, or measuring device using manners well known in the art) a plurality of data points P having a point format

P(DₙQₘ)(Dₙ₊₁Qₘ₊₁)(Dₙ₊ . . . Qₘ₊ . . . )

wherein D is a descriptor (e.g., distance) and Q is a quantifier (e.g., 500 millimeter) of the descriptor. Of course, it should be appreciated that where a data point has multiple parameters (e.g., excitation wavelength, emission wavelength, fluorescence intensity), they can be expressed as having multiple descriptors Dₙ, Dₙ₊₁, Dₙ₊ . . . with corresponding multiple quantifiers Qₘ, Qₘ₊₁, Qₘ₊ . . . , wherein n and m are 1. Thus, and among other contemplated options, D can be a physical descriptor, a monetary descriptor, an anatomical descriptor, and/or a demographic descriptor. Consequently suitable quantifiers will include numeric values, candidate name, locations, medical gradings, area codes and ZIP codes, etc.

A rule is then applied using a mathematical function, operator, and/or other input to generate from the plurality of data points P a plurality of derivative data points P′ having a data point format

$${P}^{′} ( \begin{matrix}{DQ}_{m} 1 \\ {D}_{n} {DQ}_{m} 2 \\ {DQ}_{m} 3 \\ {DQ}_{m} …\end{matrix} ) ( \begin{matrix}{DQ}_{m + 1} 1 \\ {D}_{n + 1} {DQ}_{m + 1} 2 \\ {DQ}_{m + 1} 3 \\ {DQ}_{m + 1} …\end{matrix} ) ( \begin{matrix}{DQ}_{m + …} 1 \\ {D}_{n + …} {DQ}_{m + …} 2 \\ {DQ}_{m + …} 3 \\ {DQ}_{m + …}\end{matrix} )$$

wherein the derivative quantifiers DQₘ1, DQₘ2 DQₘ3, and DQₘ . . . preferably represent a derivative fractional or collective (or identical) expression of Qₘ. For example, and using the number provided for Q above, a rule could be applied that provides results in which DQₘ1 represents “5×10̂5 micrometers”, DQₘ2 represents “500 millimeters”, DQₘ3 represents “50 centimeters”, and DQₘ . . . represents “0.5 meters”. Similar considerations apply for DQₘ₊₁, and DQₘ₊ . . . .

At least some of the data points are presented in a display format in which a unit of at least one of DQₘ1 (e.g., micrometers), DQₘ2 (e.g., millimeters), DQₘ3 (e.g., centimeters), and DQₘ . . . (e.g., meters) is used as scale for display. As already discussed above, the software is programmed to allow zooming of the display format by expanding and/or compressing the scale for display. Most preferably, a second display of the data points is concurrently presented at a predetermined expansion and/or compression of the scale (supra) in a second display format in which a second unit of at least another one of DQₘ1 (e.g., micrometers), DQₘ2 (e.g., millimeters), DQₘ3 (e.g., centimeters), and DQₘ . . . (e.g., meters) is used as scale for the second display. Alternatively, or additionally, a third display can be displayed in which one of DQₘ₊₁1, DQₘ₊₁2, DQₘ₊₁3, and DQₘ . . . is used as scale. It should be noted that in such case, zooming in and out of the display will result in a switch of display by parameter rather than by a fractional and/or multiple of an earlier scale unit.

Therefore, it should be recognized that as in the discussion above, data agglomeration and/or deconvolution is based on the use of a rule that can be triggered on demand (e.g., via zooming past a predetermined value) or via a user command via a graphic user interface. Especially contemplated rules are based on mathematical models and algorithms that automatically generate derivative quantifiers. However, in alternative aspects, suitable rules may also be based at least in part on manual user input in which the user input is employed to convert a particular quantifier into one or more derivative quantifiers. Such input is especially desirable where the quantifier is converted to a subjective and/or descriptive term (e.g., conversion of “2.8 metric tons” to “heavy”). The second display is most preferably displayed in an overlapping manner, however, alternative manners of presenting the second display are also deemed suitable and include display in a second (third, fourth, etc.) window, which may or may not at least partially overlap with the first window.

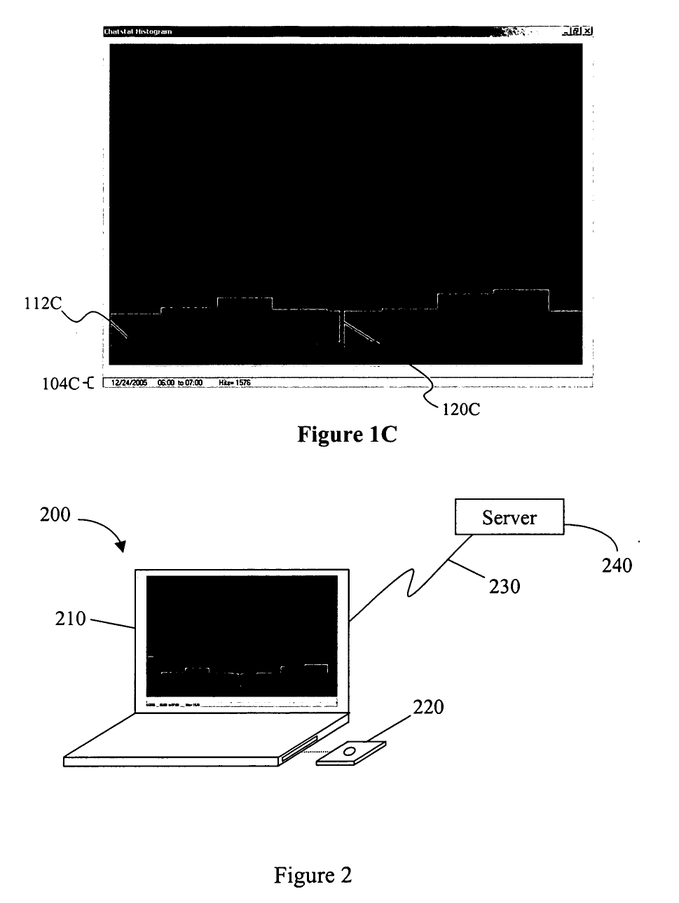

In FIG. 2, a system 200 generally includes a computer 210 that operates software (shown embodied in software product 220), and optionally a server 240 coupled to computer 210 via link 230. The computer 210 runs software 220 to: (1) present a first display of a plurality of data points in an at least two-dimensional graph using a first data point per scale resolution; (2) allow a user to zoom within the first display within a range that is characterized by at least one of a predetermined minimum and maximum of data points per scale in at least one dimension of the first display; and (3) present a second display of the plurality of data points in an at least two-dimensional graph using a second data point per scale resolution once the user zooms outside the range. In various aspects of preferred embodiments at least one of the computer 210 and the server 240 is further programmed to: (1) use at least one of a mathematical function and a manual user input to establish the second data point per scale resolution, or to establish the at least one of the predetermined minimum and maximum of data points per scale; (2) clustered the plurality of data points once the user zooms to a point exceeding the maximum data points per scale, and de-cluster a clustered plurality of data points once the user zooms to a point dropping below the minimum data points per scale; (3) provide a continuous zoom function and an optional continuous pan function in at least one of the first and second displays; (4) present first and second displays concurrently, optionally in an overlapping manner; and/or (5) present first and second displays in a format selected from the cluster consisting of a line graph, bar graph, scatter plot, and a pie graph. In any or all of these instances it is contemplated that the data points can represent a numeric value as a function of at least one of a physical descriptor, a monetary descriptor, an anatomical descriptor, and a demographic descriptor.

Thus, specific embodiments and applications of moving graphs with pan and zoom have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A computer implemented method of graphing, comprising producing or using software that allows a user to change presentation of data points in a graph between a clustered form and a de-clustered form in response to a zoom function applied to the graph.

2. The method of claim 1, wherein the software allows the user clustered data points in response to a zoom-out function, and optionally de-cluster clustered data in response to a zoom-in function.

3. The method of claim 1, wherein the software employs at least one of a mathematical function and manual user input to thereby produce the clustered or de-clustered form.

4. The method of claim 1, wherein the software allows presentation of the data points in both the clustered form and the de-clustered form, optionally in an overlapping manner.

5. The method of claim 1 wherein the graph is selected from the cluster consisting of a line graph, bar graph, scatter plot, and a pie graph.

6. The method of claim 1, wherein the software provides a continuous zoom function and an optional continuous pan function.

7. The method of claim 1 wherein the data points represent a numeric value as a function of at least one of a physical descriptor, a monetary descriptor, an anatomical descriptor, and a demographic descriptor.

8. A system having a first computer programmed to:
(1) present a first display of a plurality of data points in an at least two-dimensional graph using a first data point per scale resolution;
(2) allow a user to zoom within the first display within a range that is characterized by at least one of a predetermined minimum and maximum of data points per scale in at least one dimension of the first display; and
(3) present a second display of the plurality of data points in an at least two-dimensional graph using a second data point per scale resolution once the user zooms outside the range.

9. The system of claim 8, wherein at least one of the first and a second computer is further programmed to use at least one of a mathematical function and a manual user input to establish the second data point per scale resolution.

10. The system of claim 8, wherein at least one of the first and a second computer is further programmed to use at least one of a mathematical function and a manual user input to establish the at least one of the predetermined minimum and maximum of data points per scale.

11. The system of claim 8, wherein at least one of the first and a second computer is further programmed to clustered the plurality of data points once the user zooms to a point exceeding the maximum data points per scale, and wherein the software is further programmed to de-cluster a clustered plurality of data points once the user zooms to a point dropping below the minimum data points per scale.

12. The system of claim 8, wherein at least one of the first and a second computer is further programmed to provide a continuous zoom function and an optional continuous pan function in at least one of the first and second displays.

13. The system of claim 8, wherein at least one of the first and a second computer is further programmed to present first and second displays concurrently, optionally in an overlapping manner.

14. The system of claim 8, wherein at least one of the first and a second computer is further programmed to present first and second displays in a format selected from the cluster consisting of a line graph, bar graph, scatter plot, and a pie graph.

15. The system of claim 8 wherein the data points represent a numeric value as a function of at least one of a physical descriptor, a monetary descriptor, an anatomical descriptor, and a demographic descriptor.

16. A software product that contains code that allows a user on a computer to:
acquire a plurality of data points P having a point format P(DₙQₘ)(Dₙ₊₁Qₘ₊₁)(Dₙ₊ . . . Qₘ₊ . . . ), wherein D is a descriptor and Q is a quantifier of the descriptor;
apply a rule using at least one of a mathematical function and operator input to generate from the plurality of data points P a plurality of derivative data points P′ having a point format
$${P}^{′} ( \begin{matrix}{DQ}_{m} 1 \\ {D}_{n} {DQ}_{m} 2 \\ {DQ}_{m} 3 \\ {DQ}_{m} …\end{matrix} ) ( \begin{matrix}{DQ}_{m + 1} 1 \\ {D}_{n + 1} {DQ}_{m + 1} 2 \\ {DQ}_{m + 1} 3 \\ {DQ}_{m + 1} …\end{matrix} ) ( \begin{matrix}{DQ}_{m + …} 1 \\ {D}_{n + …} {DQ}_{m + …} 2 \\ {DQ}_{m + …} 3 \\ {DQ}_{m + …}\end{matrix} )$$
wherein DQₘ1, DQₘ2 DQₘ3, and DQₘ . . . represent at least one of a fractional, an identical, and collective expression of Qₘ;
present at least some of the data points in a display format in which a unit of at least one of DQₘ1, DQₘ2, DQₘ3, and DQₘ . . . is used as scale for display;
allow zooming of the display format by at least one of expanding and compressing the scale; and
concurrently present at a predetermined expansion or compression of the scale a second display of the at least some of the data points in a second display format in which a second unit of at least another one of DQₘ1, DQₘ2, DQₘ3, and DQₘ . . . is used as scale for the second display.

17. The product of claim 16 wherein acquisition of the data points comprises transfer of the data points from at least one of a measuring device and another computer.

18. The product of claim 16 wherein the code provides a continuous zoom function.

19. The product of claim 16 wherein the code provides a continuous pan function.

20. The product of claim 16 wherein the code present the display and the second display in an overlapping manner.

21. The product of claim 16 wherein D is selected from the cluster consisting of a physical descriptor, a monetary descriptor, an anatomical descriptor, and a demographic descriptor, and wherein Q is selected from the cluster consisting of a numeric value, a candidate name, and a medical grading.
